(19) United States
(12) Patent Application Publication
(10) Pub. No.: US 2004/0156504 A1
(43) Pub. Date: Aug. 12, 2004

(54) Method and apparatus reducing discrete components of repetitive ultra wideband signals

(76) Inventors: Shaomin Samuel Mo, Monmouth Junction, NJ (US); Alexander G. Gelman, Smallwood, NY (US)

Correspondence Address: RATNERPRESTIA, P O BOX 980, VALLEY FORGE, PA, 19482-0980, US

(21) Appl. No.: 10/737,518

(22) Filed: Dec. 16, 2003

Related U.S. Application Data
(60) Provisional application No. 60/433,919, filed on Dec. 16, 2002.
(60) Provisional application No. 60/434,331, filed on Dec. 18, 2002.

(51) Int. Cl. H04N 7/167

(52) U.S. Cl. 380/210

(57) ABSTRACT

Methods and apparatus for reducing discrete components of an Ultra Wideband (UWB) signal that includes source data having a repetitive component are disclosed. The discrete components are reduced by scrambling at least a portion of the repetitive component of the source data, inverting the source data according to a predetermined inverting function, and preparing the scrambled and inverted source data for transmission.

### RELATED APPLICATIONS

This application claims the benefit of the filing dates of the provisional applications entitled “SYMBOL BASED BI-ORTHOGONAL OPERATION TO SUPPRESS SPECTRAL LINES GENERATED BY SYNC WORDS IN UWB COMMUNICATIONS SYSTEMS”, assigned application No. 60/433,919, filed Dec. 16, 2002; and entitled “METHOD FOR APPLYING SCRAMBLING TO REPETITIVE UWB DATA TO REDUCE RIPPLES IN POWER SPECTRAL DENSITY” assigned application No. 60/434,331, filed Dec. 18, 2002; the contents of each incorporated herein by reference.

### FIELD OF THE INVENTION

The present invention relates to Ultra Wideband transmission technology and, more particular, to methods and apparatus for processing repetitive Ultra Wideband signals to reduce discrete components in power spectral density of Ultra Wideband signals.

### BACKGROUND OF THE INVENTION

Ultra Wideband (UWB) technology uses base-band pulses of very short duration spread over a wide band of frequencies to spread the energy of transmitted signals very thinly from near zero to several GHz. The techniques for generating UWB signals are well known. UWB technology is presently in use in military applications. Commercial applications will soon become possible due to a recent decision announced by the Federal Communications Commission (FCC) that permits the marketing and operation of consumer products incorporating UWB technology.

The key motivation for the FCC's decision to allow commercial applications is that no new communication spectrum is required for UWB transmissions because, when they are properly configured, UWB signals can coexist with other application signals in the same spectrum with negligible mutual interference. In order to ensure negligible mutual interference, however, the FCC has specified emission limits for the UWB applications. For example, a basic FCC requirement is that UWB systems do not generate signals that interfere with other narrowband communication systems.

The emission profile of a UWB signal can be determined by examining its power spectral density (PSD). The PSD for ideal synchronous data pulse streams based upon stochastic theory is well known. Characterization of the PSD of a “Time-Hopping Spread Spectrum” signaling scheme in the presence of random timing jitter using a stochastic approach is disclosed in an article by Moe et al. entitled “On the Power Spectral Density of Digital Pulse Streams Generated by M-ary Cyclostationary Sequences in the Presence of Stationary Timing Jitter.” (IEEE Tran. on Comm., Vol. 46, no. 9, pp. 1135-1145, September 1998.) According to this article, the power spectra of UWB signals consist of continuous and discrete components. The continuous component behaves like white noise and has less effect on narrowband communication systems than the discrete component.

UWB technology has many potential applications such as network communications and radar. These applications exhibit different overall data signatures. Data may repeat at regular intervals, for example, synchronization (sync) words of data frames, or it may be slowly changing, for example telemetry data for a relatively slowly changing process. Data may also be rapidly changing, for example the packet payloads in a communications system.

Sync words are typically constant data that, at least in fixed-length packet environments, occurs at regular intervals without changing. This type of data generates strong discrete components and ripples in the PSD of the UWB signal. These ripples may adversely effect narrowband communication systems. Thus, methods and apparatus for reducing discrete components, and thus ripples, in UWB signal transmissions are needed. The present invention fulfils this need among others.

### SUMMARY OF THE INVENTION

The present invention is signal processing methods and apparatus for reducing discrete components of an Ultra Wideband signal that includes source data having a repetitive component. The discrete components are reduced by scrambling at least a portion of the repetitive component of the source data, inverting the source data according to a predetermined inverting function, and preparing the scrambled and inverted source data for transmission.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. Included in the drawings are the following figures:

FIG. 1 is a waveform diagram of a pulse signal used by the present invention.

FIG. 2A is a waveform diagram that shows a bi-phase signal configuration.

FIG. 2B is a waveform diagram that shows a time-hopping signal configuration.

FIGS. 3A, 3B, 3C, 3D, 3E and 3F are graphs of frequency versus amplitude that are useful for describing the power spectral density of the signal configurations shown in FIGS. 2A and 2B.

FIG. 4 is a waveform diagram that is useful for describing synchronization pulses.

FIG. 5A is a graph of amplitude versus time which is useful for describing an exemplary synchronization pulse signal.

FIGS. 5B, 5C and 5D are graphs of amplitude versus frequency that are useful for describing the power spectral density of the synchronization pulse shown in FIG. 5A.

FIGS. 6A, 6C, 6E, 6G, 6I, 6K, 6M and 60 are graphs of amplitude versus time which are useful for describing several different pulse signals.

FIGS. 6B, 6D, 6F, 6H, 6J, 6L, 6N and 6P are graphs of amplitude versus frequency that are useful for describing the power spectral density of the respective pulse signals shown in FIGS. 6A 6C, 6E, 6G, 6I, 6K, 6M and 6O.

FIGS. 7 and 8 are waveform diagrams that are useful for describing pulse signal configuration used in one embodiment of the present invention.

FIG. 9 is chart that is useful for describing the generation of synch words.

FIGS. 10A, 10B, 10C, 10D, 10E, 10F, 10G and 10H are graphs of amplitude versus frequency that are useful for describing the power spectral density of the signal using 1 to 8 scramble words.

FIGS. 11A, 11B, 11C, 11D, 11E, 11F, 11G, and 11H, are graphs of amplitude versus frequency that are useful for comparing the power spectral densities shown in FIG. 10H to power spectral densities of random signals.

FIG. 12 is a waveform diagram that is useful for describing pulse signal configuration used in another embodiment of the present invention.

FIGS. 13A, 13B, 13C, 13D, 13E, 13F, 13G, 13H, and 13I are graphs of amplitude versus frequency that are useful for comparing the power spectral densities of the alternative embodiment to the power spectral densities of the exemplary embodiment and to random signals.

FIG. 14 is a block diagram of portions of an exemplary UWB communication system in accordance with the present invention.

FIG. 15 is a block diagram of an exemplary synchronizer for use in the exemplary UWB communications system of FIG. 14.

FIG. 16 is a flow chart of exemplary steps in accordance with the present invention.

### DETAILED DESCRIPTION

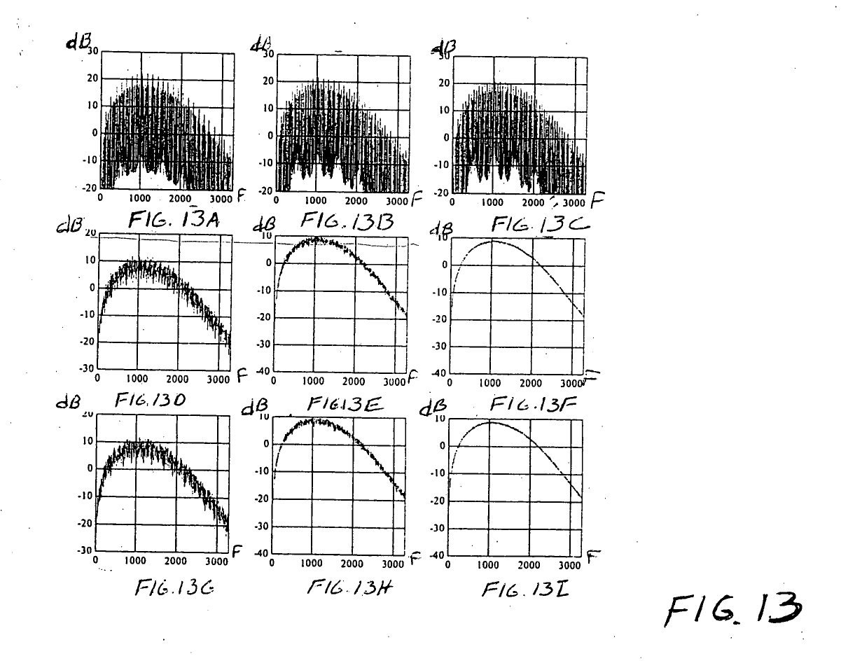

FIG. 14 is a conceptual representation of an exemplary UWB communication system 100 in accordance with the present invention. One or more blocks within the illustrated communication system 100 can be performed by the same piece of hardware or module of software. It should be understood that that embodiments of the present invention may be implemented in hardware, software, or a combination thereof. In such embodiments, the various component and steps described below would be implemented in hardware and/or software.

In general overview, a scrambler 102 scrambles slowly changing or constant source data (referred to herein as “repetitive data”) and an inverter 104 inverts portions of the source data. A transmitter then transmits the scrambled and inverted source data using an antenna 108. A receiver 112 receives the transmitted source data through another antenna 110 and correlates it using a correlator 113. An inverter⁻¹ 114 reverses the inversion of the correlated source data. A synchronizer 116 then synchronizes the scrambled source data for reversal of the scrambling using a descrambler 118 to yield the original source data. A pulse generator, such as pulse generator 120 or pulse generator 122, is positioned prior to the antenna 108 to convert digital signals to analog for transmission. The pulse generators 120, 122 are shown in dashed boxes to represent that only one is needed in a given embodiment. The components of the UWB communication system 100 are now described in detail.

The scrambler 102 scrambles at least a portion of the repetitive data. In an exemplary embodiment, the repetitive data is slow or non-changing data, e.g., sync words. The scrambler 102 scrambles the repetitive data according to a predetermined scrambling function, which is described in further detail below.

The inverter 104 inverts the source data including at least portions of the same portion of the repetitive component that is scrambled by the scrambler 102. The inverter 104 inverts the source data according to a predetermined inverting function. In an exemplary embodiment, the inverter 104 is coupled to a pseudo-random number generator 124 that generates evenly distributed binary numbers. The inverter 104 may be a multiplexer (not shown) which passes the source data or the inverse of the source data, e.g., as inverted by an inverter circuit (not shown), based on the generated binary numbers.

In the illustrated embodiment, the inverter 104 is positioned after the scrambler 102 such that the inverter 104 inverts the source data after scrambling. In other embodiments, the scrambler 102 may be positioned after the inverter 104 with the inverter inverting portions of the source data prior to scrambling by the scrambler 102.

The transmitter 106 prepares the scrambled and inverted source data for transmission from the antenna 108. The transmitter 106 may be a pulse modulator as shown or it may be a digital to analog converter (not shown) with a pulse shaping circuit (not shown), or it may simply be a connector connecting the inverter 104 or scrambler 102 to the antenna 108, and may even be considered part of the antenna 108.

The pulse generators 120 and 122 convert digital signals to analog UWB pulses for transmission via the antenna 108. In one exemplary embodiment, the pulse generator 120 is positioned between the scrambler 102 and the inverter 104. In this embodiment, the scrambler scrambles the source data in the digital domain and the inverter then inverts the source data in the analog domain. In another exemplary embodiment, the pulse generator 122 is coupled to the transmitter 106. In this embodiment, the scrambler 102 and the inverter 104 scramble and invert, respectively, the source data in the digital domain prior to conversion to UWB pulses in the analog domain by the transmitter 106.

The receiver 112 receives the scrambled and inverted UWB pulses through another antenna 110. The receiver 112 correlates, in a correlator 113, the received data to the UWB pulse shape to identify UWB pulses and convert them to digital pulses for reversal of the inversion by the inverter⁻¹ 114. In an exemplary embodiment, the correlator 113 is a matched filter correlator configured to identify and correlate incoming UWB pulses.

The inverter⁻¹ 114 reverses the inversion introduced to the source data by the inverter 104. The inverter⁻¹ 114 reverses the inversion introduced by the inverter 104 according to a predetermined inverting function that is based on the inverting function of the inverter 104. In an exemplary embodiment, the inverter⁻¹ 114 is coupled to a pseudo-random number generator 126 that generates evenly distributed binary numbers that match the evenly distributed binary numbers of the pseudo-random number generator 124. The inverter⁻¹ 114 may be a multiplexer (not shown) which passes the source data or the inverse of the source data, e.g., as inverted by an inverter logic circuit (not shown), based on the generated binary numbers. The two pseudo-random number generators 124 and 126 generate identical bit-strings. In an exemplary embodiment, the exemplary generators are configured to start at a common point when the first bit of a sequence is transmitted or received for initialization. In an alternative exemplary embodiment, the inverter 104 may invert entire sync words on a random basis and the initialization of the pseudo-random number generator 126 in the receiver may be linked to the detection of a valid synch word.

The synchronizer 116 synchronizes the received data for descrambling by the descrambler 118. The descrambler 118 then reverses the scrambling introduced by the scrambler 102 to yield the original source data. The descrambler 118 reverses the scrambling according to a predetermined descrambling function that is based on the scrambling function used by the scrambler 102. In the illustrated embodiment, the synchronizer 116 receives feedback from the descrambler 118 in synchronizing the scrambled source data. Further details regarding the synchronization of the scrambled source data are described below.

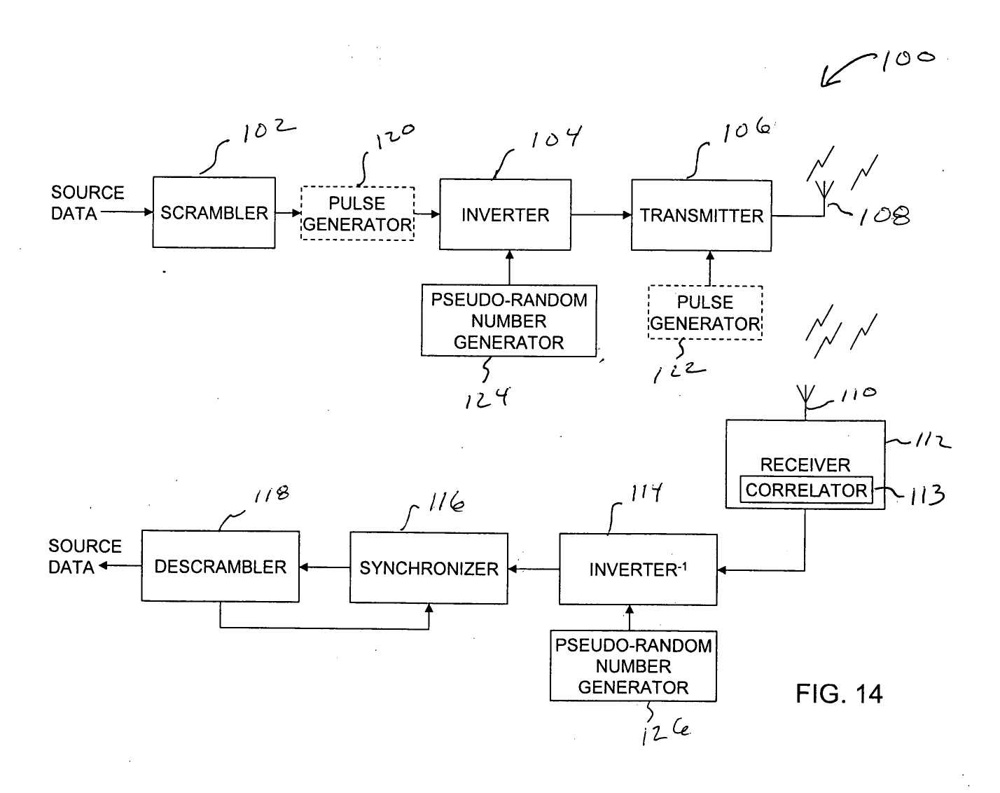

FIG. 15 depicts a suitable synchronizer 116 for use in the present invention. The illustrated synchronizer is a four pattern synchronizer based on four words I-IV, which were used to scramble the source data. The first pattern S1 includes the four words in sequential order from I-IV. The second pattern S2 includes the four words starting with IV followed by I, II, and III. The third pattern S3 is III, IV, I, II and the fourth pattern S4 is II, III, IV, I. The received sequence, r, is exclusively ORed, XOR, with each of the four patterns S1-S4 using XOR logic circuits 150a-d. Absolute value components (ABS) 152a-d find the absolute value of the resultant values produced by the XOR logic circuits 150a-d. A maximum value circuit 154 then determines which patterns S1-S4 produces the maximum absolute value when combined with the received sequence, r, and controls a multiplexer 156 such that the determined pattern is passed by the multiplexer 156 for use in descrambling the received sequence. In embodiments where the inverter 104 inverts entire sync words on a random basis, the use of absolute value components 152a-d in the synchronizer 116 enables the detection of a valid sync word in the receive data prior to inversion by the inverter⁻¹ 114. The detected sync word may then serve as the basis for initializing the pseudo random number generator 126.

Referring back to FIG. 14, in the illustrated embodiment, the descrambler 118 is positioned after the output of the inverter⁻¹ 114 such that the source data is inverted and then descrambled. In an alternative embodiment, the inverter⁻¹ 114 may be positioned after the output of the descrambler 118 with the descrambling and inversion performed in the opposite order.

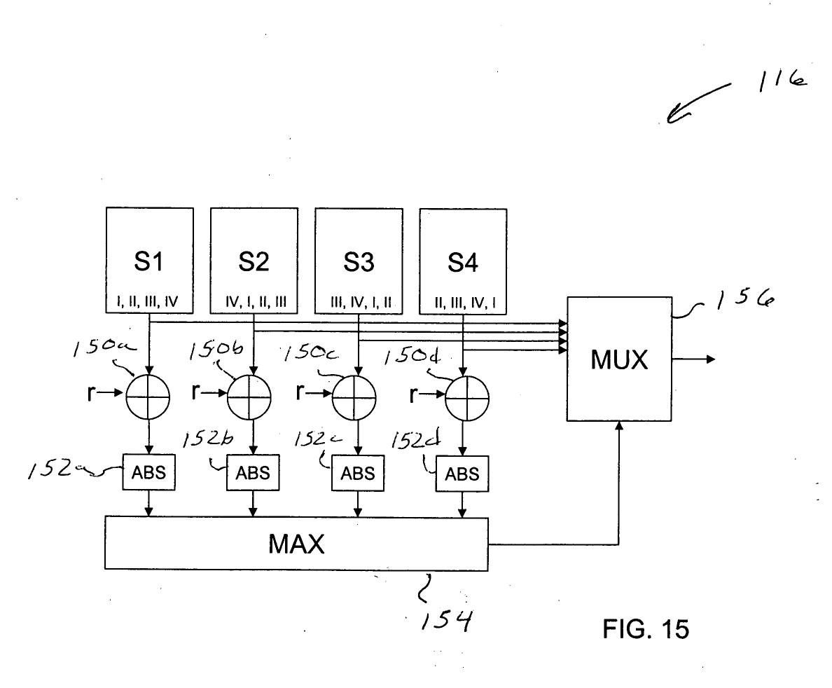

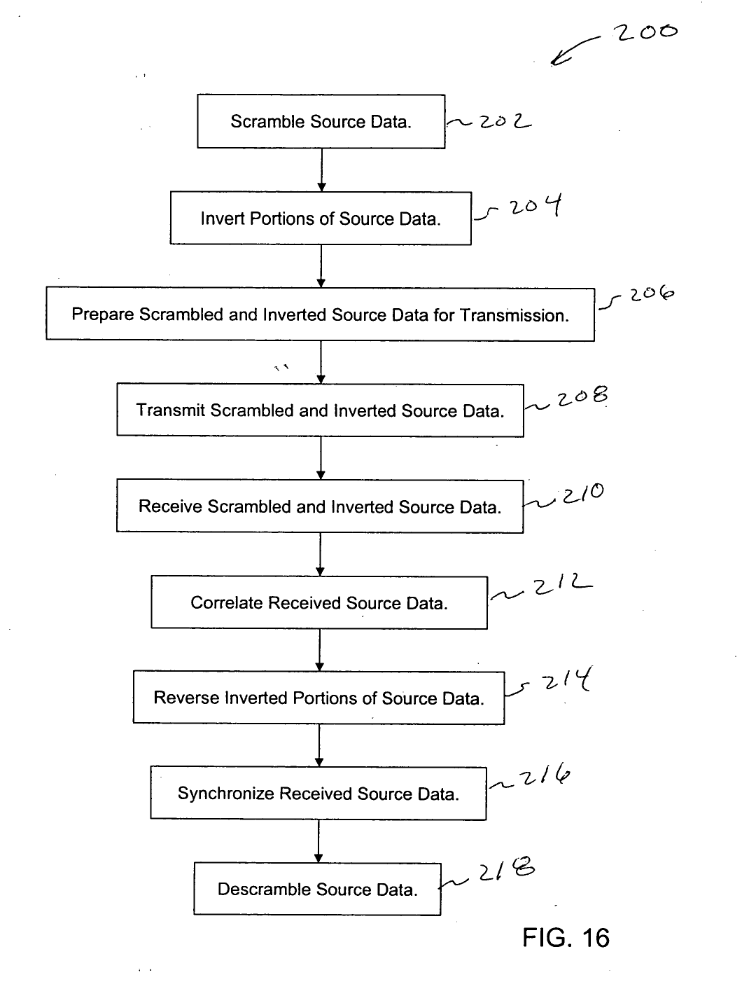

FIG. 16 depicts a flow chart 200 of exemplary UWB communication steps. The steps of flow chart 200 are described with reference to the components of FIG. 14.

At block 202, the scrambler 102 scrambles the source data. The source data may include frames of data including payload data and non-payload data such as synchronization data. In an exemplary embodiment, at least a portion of a repetitive component of the source data is scrambled according to a predetermined scrambling function, e.g., using scrambling words, which are described in further detail below. If the portion of the repetitive data is sync words, the scrambler 102 may scramble the sync words using the scrambling words. In an exemplary embodiment, the repetitive data is comprised of bipolar symbols of either +1 or −1 and the sync words are all one symbol such as all +1.

At block 204, the inverter 104 inverts portions of the source data. In an exemplary embodiment, the portions of the source data inverted by the inverter 104 includes at least the portions of the source data scrambled by the scrambler 102 and inverts the data according to a predetermined inverting function, e.g., using a set of evenly distributed binary numbers. In one exemplary embodiment, the repetitive data includes sync words and the inverter 104 inverts select symbols within the sync words. In other exemplary embodiments, the inverter 104 inverts select symbols in select frames or inverts all source data.

In the illustrated flow chart 200, source data is first scrambled (block 202) and then inverted (block 204). It will be understood by those of skill in the art that in other embodiments the source data may first be inverted and then scrambled, in which case the steps of blocks 202 and 204 are reversed.

At block 206, the scrambled and inverted source data is prepared for transmission. The source data may be prepared for transmission by using it to modulate pulses provided by a pulse generator, such as pulse generator 120 or 122. At block 208, the transmitter 106 transmits the scrambled and inverted source data from the antenna 108.

At block 210, the receiver 112 receives the scrambled and inverted source data through another antenna 110 and, at block 212, the receiver 112 correlates the source data. At block 214, the inverter⁻¹ 114 reverses the inversion introduced by the inverter 104.

At block 216, the synchronizer 116 synchronizes the received scrambled source data for reversal of the scrambling applied by the scrambler 102. In an exemplary embodiment, the synchronizer 116 synchronizes the scrambles and inverted source data based on feedback from the descrambler 118. At block 218, the descrambler 118 reverses the scramble introduced by the scrambler 102 to derive the original source data.

In the illustrated flow chart 200, source data is first inverted (block 214) by the inverter⁻¹ 114 and then descrambled (block 218) by the descrambler 118. It will be understood by those of skill in the art that in other embodiments the source data may first be descrambled and then inverted, in which case the steps of blocks 214 and 218 are reversed.

In order to more fully understand the invention, it is helpful to understand the Power Spectral Density (PSD) of a clocked random sequence, and then understand the PSD of sync words in a fixed frame length communication system.

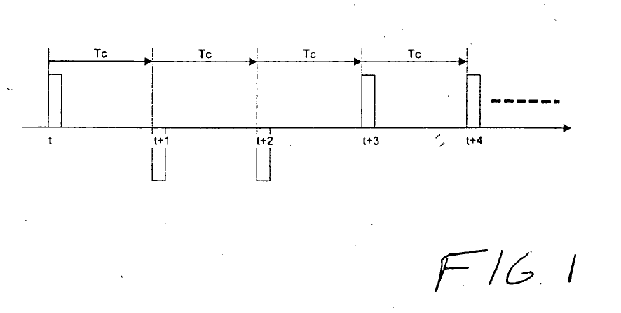

Clocked random sequences are now analyzed. Assume that a digitally controlled signal is used that produces random transmissions at multiples of the basic clock period Tc. This signaling technique is shown in FIG. 1 and is modeled as shown in equation (1).

$$s ( t ) = {\sum }_{n = - ∞}^{∞} {a}_{n} w ( t - {nT}_{c} ) \qquad ( 1 )$$

where {aₙ} is an unbalanced binary independent identically distributed (i.i.d.) random sequence. The probability function of {aₙ} is given b equation (2)

$$Pr \{ {a}_{n} \} = \{ \begin{matrix}p , & {a}_{n} = 1 \\ 1 - p , & {a}_{n} = - 1\end{matrix} \qquad ( 2 )$$

The continuous component and discrete components of the PSD may be represented as shown in equations (3) and (4).

$$\begin{matrix}{S}^{c} ( f ) = \frac{1}{Tc} {\vert W ( f ) \vert}^{2} \{ 1 - {( 2 p - 1 )}^{2} \} & ( 3 ) \\ {S}^{d} ( f ) = \frac{{( 2 p - 1 )}^{2}}{{Tc}^{2}} {\sum }_{l = - ∞}^{∞} {\vert W ( \frac{l}{Tc} ) \vert}^{2} {δ}_{D} ( f - \frac{l}{Tc} ) & ( 4 )\end{matrix}$$

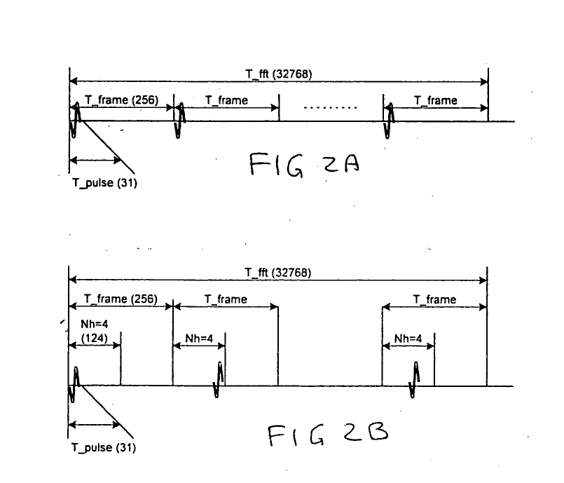

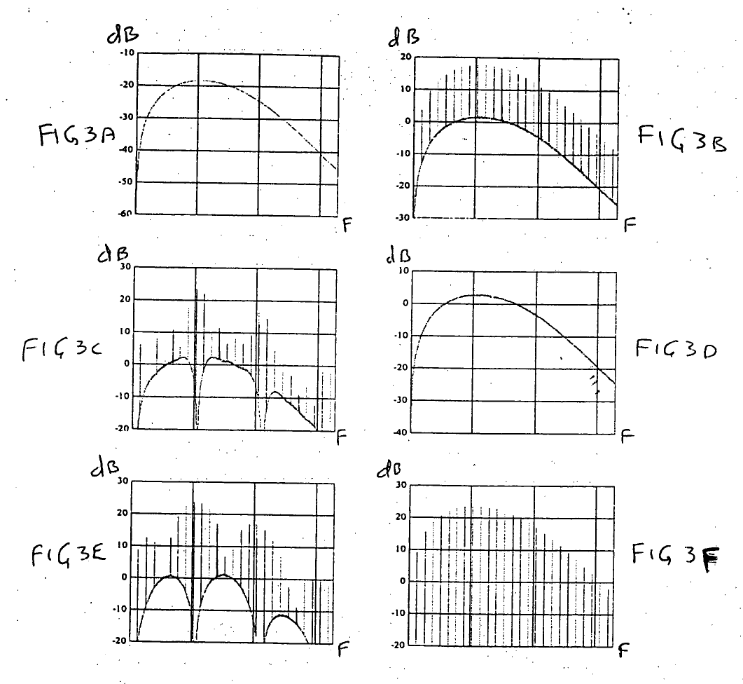

The signal configurations shown in FIGS. 2A and 2B are simulated to produce the PSD's shown in FIGS. 3A through 3F. The simulation uses Periodogram PSD estimators to calculate PSD of different UWB signals. The simulation is configured as follows: the single pulse is represented by 31 samples and frame size Tc takes 256 samples. A 32768-point FFT is used on 32768 samples to evaluate the PSD. Because a single estimate may generate a large bias in estimation and because of the limits on average PSD specified in the FCC regulations, 500 estimates of PSD are used to smooth the overall PSD estimate.

FIG. 3A shows the Power Spectrum of a single pulse. FIG. 3C shows the PSD of pulses of the Time-Hopping configuration, shown in FIG. 2B, with possible hop times Nh=4. FIG. 3E shows the PSD of pulses of Time-Hopping with possible hop times Nh=2. FIG. 3B shows the PSD of pulses of the bi-phase configuration, shown in FIG. 2A, with probability p=0.25. FIG. 3D shows the PSD of pulses of the bi-phase configuration with probability p=0.5 and FIG. 3F shows the PSD of the bi-phase configuration with probability of p=1.0. It is noted that FIG. 3F is also the PSD of the Time-Hopping configuration with hop times Nh=1.

The PSD in FIG. 3D is obtained after sequence s(t) is processed by operations introduced to randomly invert sync words, as described in a U.S. Patent Application by Mo et al. entitled SELECTIVE DATA INVERSION IN ULTRA-WIDE-BAND COMMUNICATIONS TO ELIMINATE LINE FREQUENCIES, filed Dec. 2, 2002. This PSD has the lowest peak value and no line frequency compared with other cases, i.e., time-hopping (3C and 3E) and binary orthogonal processing with p≠0.5 (i.e. as shown in FIGS. 3B and 3F).

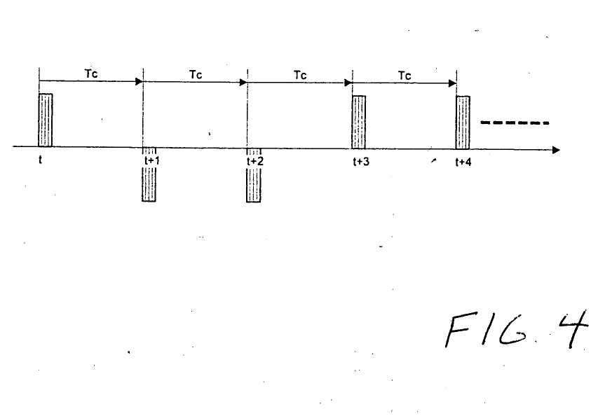

The PSD of sync words are now analyzed. In current wireless implementations, sync words are widely used for frame synchronization and multiple access. The sync words are usually transmitted at multiples of the basic clock period Tc shown in FIG. 4, similar to the previous example shown in FIG. 1. In FIG. 4, however, the rectangles represent sync words that each consist of several symbols.

A sync word consists of J symbols and symbol time is denoted by Tb. Similar to the previous example, a generic model of a sync word is given by equation (5).

$${S}_{s} ( t ) = {\sum }_{n = - ∞}^{∞} {\sum }_{j = 0}^{J - 1} {a}_{n , j} w ( t - nTc - jTb ) \qquad ( 5 )$$

Applying the operations described in the above-referenced U.S. patent application, a new sequence {cₙ} is obtained as shown in equation (6):

$${S}_{s} ( t ) = {\sum }_{n = - ∞}^{∞} {c}_{n} {w}_{s} ( t - nTc ) \qquad ( 6 )$$

The probability function of {cₙ} is given by equation (7)

$$Pr \{ {c}_{n} \} = \{ \begin{matrix}0.5 , & {c}_{n} = 1 \\ 0.5 , & {c}_{n} = - 1\end{matrix} \qquad ( 7 )$$

In doing this, an unbalanced sequence becomes balanced and all energy goes to the continuous component of the PSD.

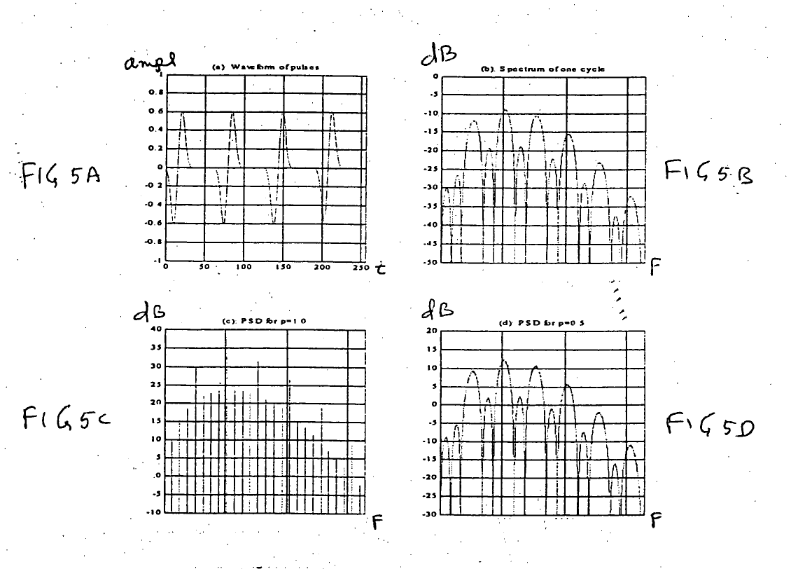

FIGS. 5A-5D show an exemplary sync word with four pulses and its PSD in two different cases. FIG. 5A shows the sync word with four pulses, FIG. 5B is the Power Spectrum of a single sync word, FIG. 5C is the PSD of a sequence of the sync words, and FIG. 5D is the PSD of a sequence of sync words that has been processed by the method described in the above-referenced patent application.

Comparing FIGS. 5C and 5D it is noted that using this scheme the discrete components of the PSD related to the sync words can effectively be suppressed, reducing the peak value of the PSD by about 20 dB.

As shown in FIG. 5B, however, as the basic element in the signal sequence {cₙ} does not keep the same spectral shape as the sequence {aₙ} there are ripples in the PSD of {cₙ} that do not exist in {aₙ}. These ripples indicate that the frequencies are not used effectively. No matter what operations are performed on the sequence {cₙ}, therefore, the PSD shown in FIG. 3D can not be obtained. In other words, the PSD of the sequence can not be made close to the Power Spectrum of the pulse commonly used in UWB communication systems.

The PSD of words with multiple pulses is now analyzed. A more generic analysis based on the shape of the PSD of multiple pulses is presented below. The multiple pulses can be modeled as shown in equations (8) and (9).

$$\begin{matrix}{s}_{m} ( t ) = {\sum }_{n = - ∞}^{∞} {\sum }_{j = 0}^{J - 1} {a}_{n , j} w ( t - nTc - jTb ) & ( 8 ) \\ = {\sum }_{n = - ∞}^{∞} ( {\sum }_{{j}_{1}} {a}_{n , {j}_{1}} w ( t - nTc - {j}_{1} Tb ) + & ( 9 ) \\ {\sum }_{{j}_{2}} {a}_{n , {j}_{2}} w ( t - nTc - {j}_{2} Tb ) ) & \end{matrix}$$

If {a_{n,j1}} are correlated as sync words and {a_{n,j2}} are independent from a_{n,j1} and independent from each other similar to payload data, because {a_{n,j1}} are dependent, it can be further assumed that

a_{n,j}_{₁}=bⱼ_{₁}a_{n,0}, where bⱼ_{₁}=1 or −1

With above assumption, sₘ(t) can be described by equation (10)

$$\begin{matrix}{s}_{m} ( t ) = {\sum }_{n = - ∞}^{∞} ( {a}_{n , 0} {\sum }_{{j}_{1} ∈ {J}_{1}} {b}_{{j}_{1}} w ( t - nTc - {j}_{1} Tb ) + \\ {\sum }_{{j}_{2} ∈ {J}_{2}} {a}_{n , {j}_{2}} w ( t - nTc - {j}_{2} Tb ) )\end{matrix} \qquad ( 10 )$$

From the above, the continuous component and the discrete component of the PSD of sₘ(t) can be written as shown in equations (11) and (12)

$$\begin{matrix}{S}_{m}^{c} = \frac{1}{Tc} {\vert W ( f ) \vert}^{2} \{ 1 - {( 2 p - 1 )}^{2} \} & ( 11 ) \\ ( {\sum }_{{j}_{1} ∈ {J}_{1}} {\sum }_{{k}_{1} ∈ {J}_{1}} {b}_{{j}_{1}} {b}_{{k}_{1}} {ⅇ}^{j 2 π f ( {j}_{1} - {k}_{1} ) {T}_{b}} + {\sum }_{{j}_{2} ∈ {J}_{2}} 1 ) & \\ {S}_{m}^{d} = \frac{{( 2 p - 1 )}^{2}}{{Tc}^{2}} {\sum }_{l = - ∞}^{∞} {\vert W ( \frac{l}{Tc} ) \vert}^{2} & ( 12 ) \\ {\vert {\sum }_{{j}_{1} ∈ {J}_{1}} {b}_{{j}_{1}} {ⅇ}^{j 2 π ( l ) {j}_{1} \frac{Tb}{Tc}} + {\sum }_{{j}_{2} ∈ {J}_{2}} {b}_{{j}_{2}} {ⅇ}^{j 2 π ( l ) {j}_{2} \frac{Tb}{Tc}} \vert}^{2} {δ}_{D} ( f - \frac{l}{Tc} ) & \end{matrix}$$

Applying the processing scheme described in the above-referenced patent application is equivalent to choosing p=0.5 and tends to make Sₘ^{d} vanish. The continuous component then may be represented by equations (13) and (14).

$$\begin{matrix}{S}_{m}^{c} = \frac{1}{Tc} {\vert W ( f ) \vert}^{2} ( {\sum }_{{j}_{1} ∈ {J}_{1}} {\sum }_{{k}_{1} ∈ {J}_{1}} {b}_{{j}_{1}} {b}_{{k}_{1}} {ⅇ}^{j 2 π f ( {j}_{1} - {k}_{1} ) {T}_{b}} + {\sum }_{{j}_{2} ∈ {J}_{2}} 1 ) & ( 13 ) \\ = \frac{1}{Tc} {\vert W ( f ) \vert}^{2} ( {J}_{1} + {J}_{2} ) & ( 14 )\end{matrix}$$

In the above equation, there are two terms in the bracket: J₁ and J₂. Because J₂ does not contain frequency components, it does not affect the shape of Sₘ^{c}. The term J₁, however, does contain frequency components and these components change the shape of Sₘ^{c}, generating ripples.

In order to make Sₘ^{c} follow W(f), it is desirable to reduce or remove the frequency components in J₁. In other words, the dependency among the pulses should be reduced or removed.

The power spectra of multiple pulses is now analyzed, a mechanism to scramble sync words is proposed and results of a simulation of the method are provided. In this section, the power spectra of words with four pulses are analyzed. The values of these words are shown in Table 1

TABLE 1

| | |
|---|---|
| 0: | 0 0 0 0 |
| 1: | 0 0 0 1 |
| 2: | 0 0 1 0 |
| 3: | 0 0 1 1 |
| 4: | 0 1 0 0 |
| 5: | 0 1 0 1 |
| 6: | 0 1 1 0 |
| 7: | 0 1 1 1 |

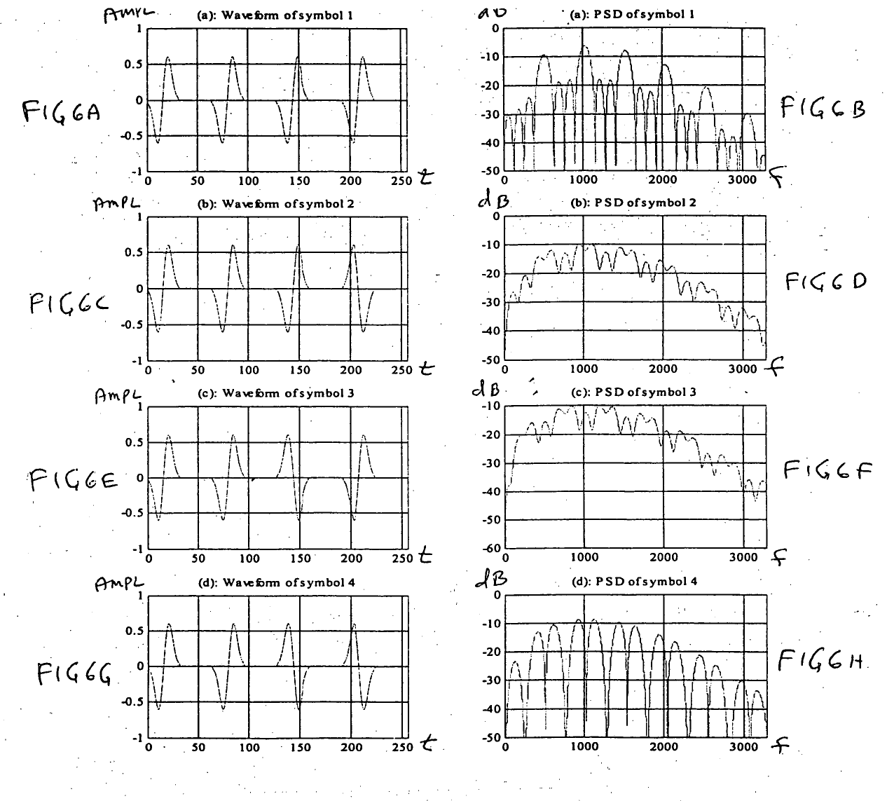

One binary digit is represented by one pulse. The power spectra of the words are shown in FIGS. 6A through 6P, in which waveforms of the words are on the left side and the corresponding spectra are on the right side. It is clear that different waveforms have different spectral shapes, which suggests that a combination of the words may reduce the frequency dependent terms, or J₁ in the Sₘ^{c}, and make the spectral shape similar to that of the pulse shown in FIG. 3A.

In an exemplary embodiment, using the processing scheme introduced in the above-referenced patent application, the discrete component of the PSD of words with multiple pulses can be effectively suppressed as shown in FIG. 5D.

As described above, the best way to remove the dependency among pulses is to make them completely independent. Completely randomized sync words, however, may make the synchronization operation difficult or impossible. Instead, a mechanism is proposed to reduce the dependency among pulses in sync words but still provide some pattern in the sync words that may be used for synchronization.

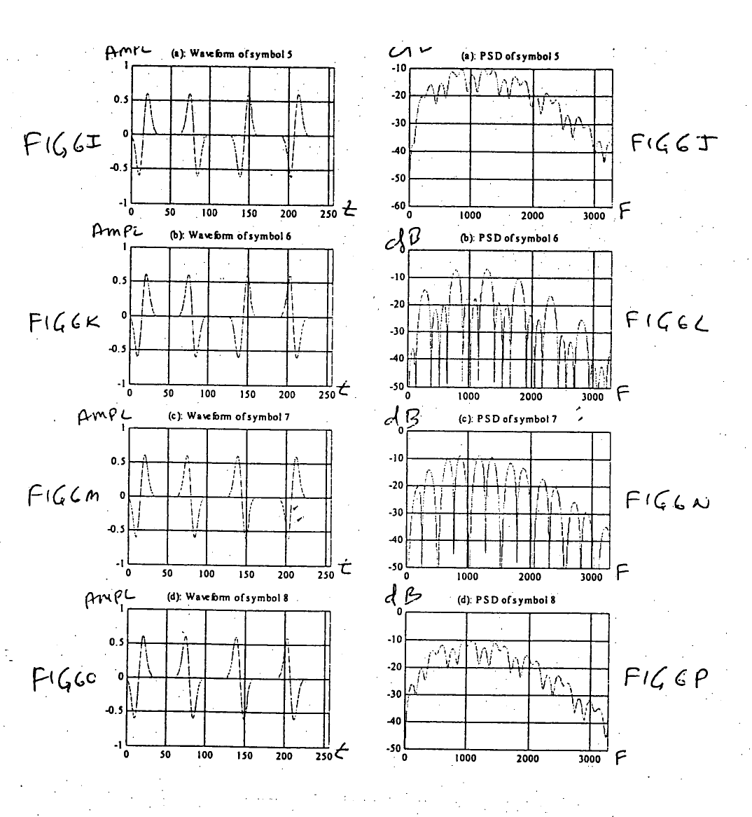

The following assumptions are made for the sync words. These assumptions are illustrated in by the waveform diagram shown in FIG. 7.

1. A sync word consists of N symbols

2. A symbol consists of n pulses

3. The total number of pulses in a sync word is n*N pulses.

A scrambler array SA is built that consists of M symbols with each symbol consisting of n pulses. The M symbols are different from each other. Then, the following steps are taken to process the sync words, SYNC.

1. Set initial value of m such that 1≦m≦M;

2. Set m=m+1 mod M;

3. Use the m as an index to the scrambler array SA to obtain one symbol;

4. Go to step 2 until N symbols have been obtained. These N symbols are arranged in the following format to construct a new word SW;

SW=[SA(m), SA(m+1 mod M), SA(m+2 mod M), . . . , SA(m+(N−1) mod M)]

5. Scramble the sync words by applying XOR operation, ⊕, to the sync word SYNC and the generated SW to form a new word SSW1;

SSW1=SYNC⊕SW

6. Invert portions of the sync words by generating an evenly distributed binary number c ⊂(1, −1) and using it as a control word to generate a new word SSW2;

$$SSW2 = \{ \begin{matrix}SSW1 , & {c}_{n} = 1 \\ \overline{SSW1} , & {c}_{n} = - 1\end{matrix}$$

7. SSW2 is used as the new sync word for transmission;

8. Go to step 2 for the next sync word. The starting index of next symbols in SW can be calculated as

m=m+N mod M

On the receiver side, assuming the sync word is all one symbol, e.g., +1, the following operation is performed on the received sequence r(n) to achieve synchronization:

1. If this is the initial acquisition, do the operations described in this step and step 2, otherwise go to step 3 because the index of the sync word can be calculated when the previous sync word is generated. Pseudo code for finding the first scramble word is shown in Table 2:

TABLE 2

```
for (m=1; m<=M; m++)
{
    SW(m) = [SA(m), SA(m+1 mod M), SA(m+2 mod M), ...,
    SA(m+(N−1) mod M)] I = ΣSW(m) * r(n)
}
```

2. select the m with the maximum magnitude for I as the initial value of m;

3. Reverse the inversion by applying the evenly distributed binary number used for transmission;

4. Construct SW=[SA(m), SA(m+1 mod M), SA(m+2 mod M), . . . , SA(m+(N−1) mod M)] for use in de-scrambling the sync word;

5. Calculate the index of m for the next sync word, m=m+N mod M;

6. Go to step 4.

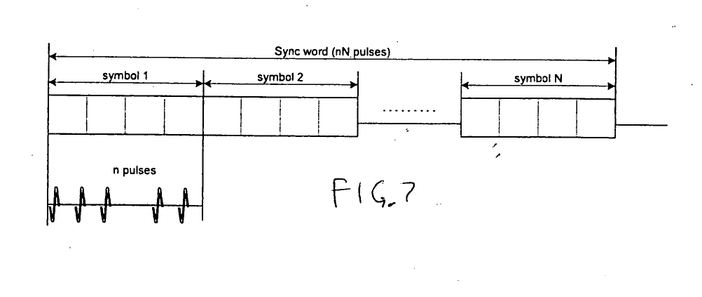

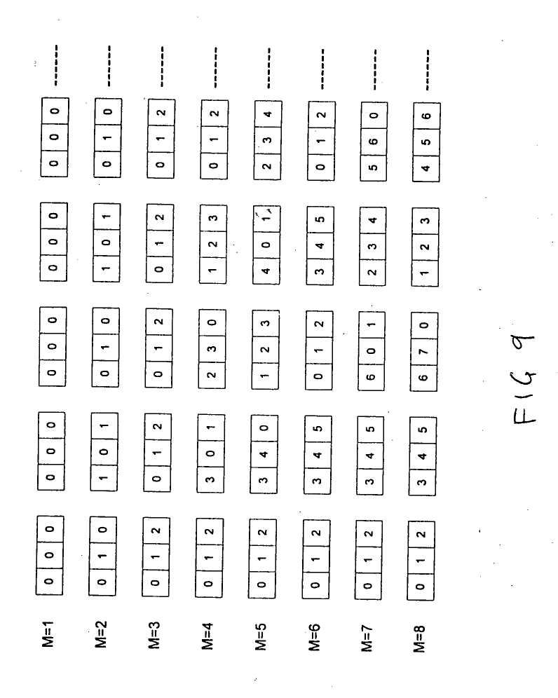

An analysis of a simulation for this exemplary embodiment is now provided. The signal configuration shown in FIG. 8 is simulated and the results are shown in FIGS. 10A through 10H. The simulation uses Periodogram PSD estimators to calculate PSD of different UWB signals. The simulation is configured as follows: a single pulse is represented by 31 samples followed by 33 samples of zero padding, a symbol consists of 4 pulses and is represented by 256 samples, a sync word consists of 3 symbols and is represented by 768 samples, and frame size Tc takes 1024 samples. A 32768-point FFT is used on 32768 samples to evaluate the PSD. Because a single estimate usually generates a large bias in estimation and because the FCC regulations specify limits on the average PSD, 500 estimates of PSD are used to smooth the PSD estimate.

For the simulation, a scrambler array SA is constructed as

SA=[0 0 0 0, 0 0 0 1, 0 0 1 0, 0 0 1 1, 0 1 0 0, 0 1 0 1, 0 1 1 0, 0 1 1 1]

Four binary bits can generate 16 different symbols. Because of the processing in step 6 to toggle the sync word controlled by c ⊂(1, −1), however, only half of the 16 symbols are unique. The other half may be obtained by toggling (i.e. inverting) these eight symbols. Hence only eight symbols are selected in the SA.

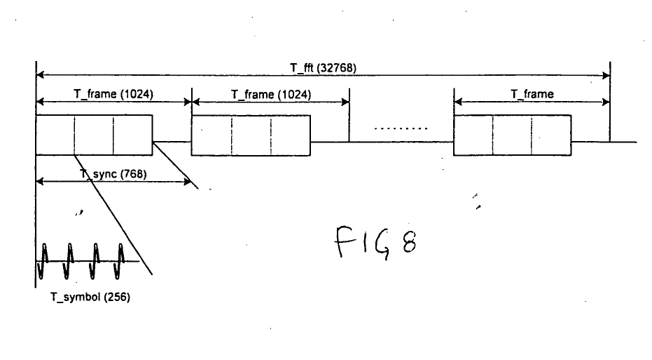

In the simulation, a sync word consists of three symbols, or N=3; a symbol consists of four pulses, or n=4. Thus, the sync word contains 12 pulses. In the simulation, M=1, 2, . . . , 7, 8 symbols are used and only the first M symbols in the SA array are used to construct SW. Assuming an initial value of index m=1, FIG. 9 lists the symbol index used for five consecutive sync words for different values of M. These indexes are used to construct the SWs that will be used along with the sync word, SYNC, to produce SSW1. It is noted that when only one symbol is used, or M=1, the operation is equivalent to using the original sync word because SA(0)=(0 0 0 0) and combining any data value in an exclusive-or operation with (0 0 0 0) does not change that data value.

An example is given to illustrate how the scheme works. In the example M=4 and the sync word has three symbols SYNC=(0000 0000 0000) in binary. Assume the initial index m=0 as shown in FIG. 9.

For the first sync word, m=0,

SW=[SA(0) SA(1 mod 4)SA(2 mod 4)]=[SA(0)SA(1)SA(2)]=(0000 0001 0010)

SSW1=SYNC⊕SW=(0000 0001 0010)

m=m+3 mod 4=0+3 mod 4=3 is used for next sync word.

For the second sync word, m=3,

SW=[SA(3)SA(4 mod 4)SA(5 mod 4)]=[SA(3)SA(0)SA(1)]=(0011 0000 0001)

SSW1=SYNC⊕SW=(0011 0000 0001)

m=m+3 mod 4=3+3 mod 4=2 is used for next sync word.

For the third sync word, m=2,

SW=[SA(2)SA(3 mod 4)SA(4 mod 4)]=[SA(2)SA(3)SA(

SSW1=SYNC⊕SW=(0010 0011 0000)

m=m+3 mod 4=2+3 mod 4=1 is used for next sync word.

For the fourth sync word, m=1,

SW=[SA(1)SA(2 mod 4)SA(3 mod 4)]=[SA(1)SA(2)SA(3)]=(0001 0010 0011)

SSW1=SYNC⊕SW=(0001 0010 0011)

m=m+3 mod 4=1+3 mod 4=0 is used for next sync word.

For the fifth sync word, m=0, processing is the same as in the first word. The above four cases repeat for the subsequent sync words.

Results of the simulation are plotted in FIGS. 10A through 10H in which the PSDs of the scrambled words using from one symbol to eight symbols are shown. From these results, it is seen that:

When more symbols are used, or the larger the M, the PSDs become smoother and closer to the Power Spectrum of the pulse shown in FIG. 3A.

When more symbols are used, the peak values of the PSD become smaller. The PSD of the sync word scrambled using 8 symbols is about 10 dB lower than the PSD of the original sync word. Note that scrambling with one symbol is equivalent to using the original sync word without scrambling.

The mechanism can also be used to scramble other constant data or slowly changing non-payload data.

Another simulation was conducted to compare the performance in ripple suppression of the proposed scheme to one in which all pulses are randomly generated. Signal configurations of the simulation are the same as that shown in FIG. 8. In the case of randomly generated pulses, however, 12 pulses in the frame are randomly and independently generated.

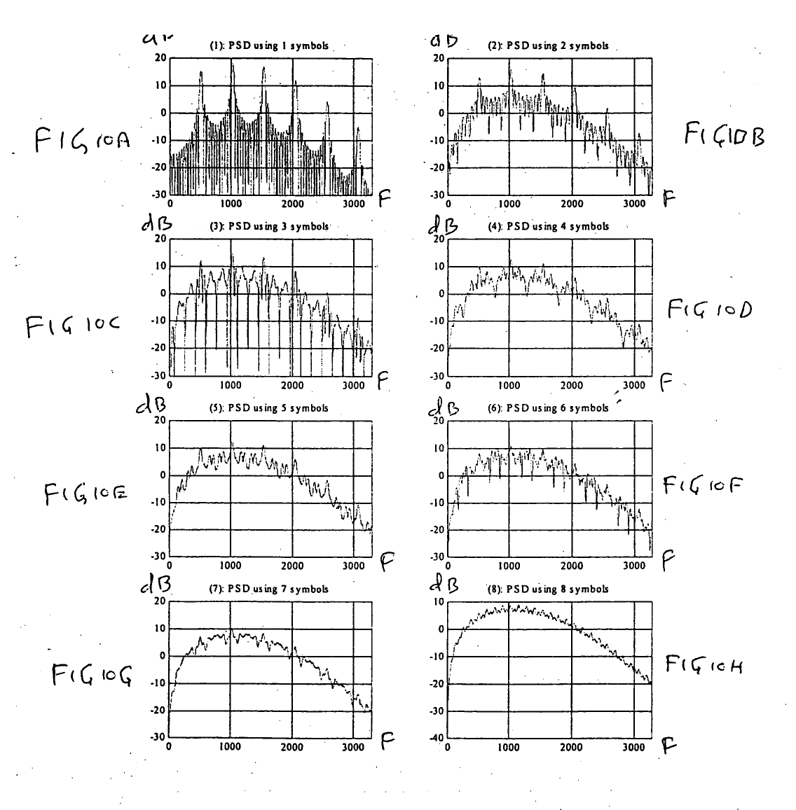

The results of this second simulation are shown in FIGS. 11A through 11H, in which the PSDs of the proposed scheme are plotted on the left side (FIGS. 11A, 11C, 11E, and 11G) and the corresponding PSDs of the randomly and independently generated pulses are plotted on the right side (FIGS. 11B, 11D, 11F, and 11H). In the FIGS., estimates at 1 run, 10 runs, 50 runs and 500 runs are plotted. The results showed that:

The PSD of randomly and independently generated pulses can be considered as the statistical lower bound of the PSD. They may be used in the simulation as references to evaluate the performance of the proposed scheme.

The PSDs of the exemplary embodiment are close to the power spectrum of the pulse given in FIG. 3A, indicating that the spectrum is efficiently utilized.

The PSD of the exemplary embodiment is very close to that of the reference. The peak value of the reference is 7.92 dB while the peak value of the PSD of the exemplary embodiment is 8.98 dB, about 1 dB degradation.

When the exemplary embodiment is used to generate the sync words, the receivers calculate M sync-word-based correlations for initial acquisition. Because the index into the scrambler array for the next frame can be calculated during the current frame, the sync word for following frames can be predicted; therefore only one sync-word-based correlation is needed after initial acquisition. This simplifies implementation of the receiving aspect of the inventive method.

Unlike a polynomial-based system, the method of the exemplary embodiment is free of error propagation.

An alternative exemplary embodiment is now described. In this embodiment, a symbol-based mechanism for bi-orthogonal operation is proposed to further suppress the residual line frequencies of the previously discussed embodiment.

A scrambler array SA is built in same way as the previously described exemplary embodiment. The following steps are taken to process sync words, SYNC.

1. Set initial value of m such that 1≦m≦M;

2. Set m=m+1 mod M;

3. Use the m as an index to the scrambler array SA to obtain one symbol;

4. Go to step 2 until N symbols have been obtained. These N symbols are arranged in the following format to construct a new word SW;

SW=[SA(m), SA(m+1 mod M), SA(m+2 mod M), . . . , SA(m+(N−1)mod M)]

5. Scramble the sync words by applying a XOR operation on the sync word SYNC and the generated SW to form a new word SSW1;

SSW1=SYNC⊕SW=SSW1(1, . . . , N)

6. Invert pulses within portions of the sync words by generating an evenly distributed binary number cₙ⊂(1, −1) and using it as a control word to generate a new word SSW2;

$$SSW2 ( n ) = \{ \begin{matrix}SSW1 ( n ) , & {c}_{n} = 1 \\ \overline{SSW1 ( n )} , & {c}_{n} = - 1\end{matrix}$$

7. SSW2 is used as the new sync word for transmission;

8. Go to 2 for the next sync word.

In fact, the starting index of the next symbols in SW for next sync word can be calculated as

m=m+N mod M

On the receiving side, the following operation is followed on received sequence r(l) to make synchronization:

1. If this is the initial acquisition, do the operations described below, otherwise go to step 3 because the index of the sync word can be calculated when the previous sync word is generated. Pseudo code for finding the first scramble word is shown in Table 3:

TABLE 3

```
for (m=1; m<=M; m++)
{
    for (n=1 ; n<=N; n++)
    {
        SW(m,n) =SA(m+(n−1) mod M);
        sum(n)= abs(SW(m,n) * r(l,n));
        I = I + sum(n);
    }
}
```

In the above pseudo code, (1, −1) is used as values for SW(m,n) and r(l,n), SW(m,n)* r(l,n), is logical multiplication, abs is an operation of taking absolute value.

2. The m is selected at which the maximum magnitude of I is obtained;

3. The scrambling and inverting is then reversed by obtaining SW as follows:

$$SA ( m + n ) = \{ \begin{matrix}SW ( m , n ) & if sum ( n ) > 0 \\ \overline{SW ( m , n )} & if sum ( n ) < 0\end{matrix}$$

SW=[SA(m), SA(m+1 mod M), SA(m+2 mod M), . . . , SA(m+(N−1) mod M)] and using it to de-scramble the sync word;

4. Calculate the index of m for the next sync word, m=m+N mod M;

5. Go to step 3.

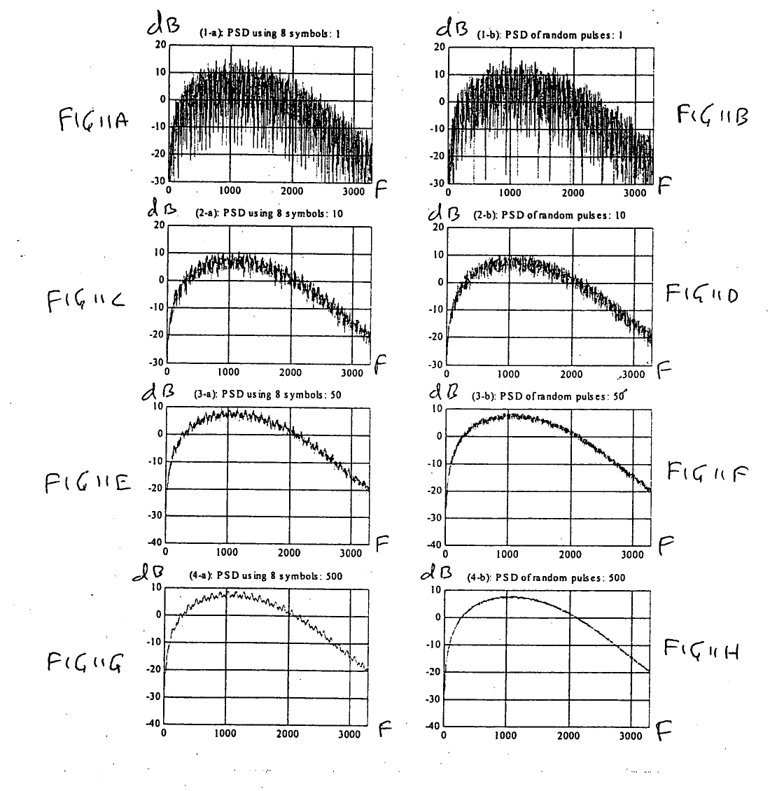

A simulation for the alternative exemplary embodiment is now analyzed. The simulation is performed using the configuration shown in FIG. 12. The simulation uses Periodogram PSD estimators to calculate the PSD of different UWB signals. The simulation is configured as follows: a single pulse is represented by 31 samples followed by 33 samples of zero padding, a symbol consists of 4 pulses and is represented by 256 samples. The frame size used in the simulation is represented by 1024*16. Different sync words are constructed correspondingly with 4(16−1)+3 symbols for each sync word, or 1024(16−1)+768 samples. A 32768-point FFT is used on 32768 samples to evaluate the PSD. Because a single estimate usually generates a large bias in estimation and the FCC regulation gives a limit on average PSD, 500 estimates of PSD are used to smooth the PSD estimate.

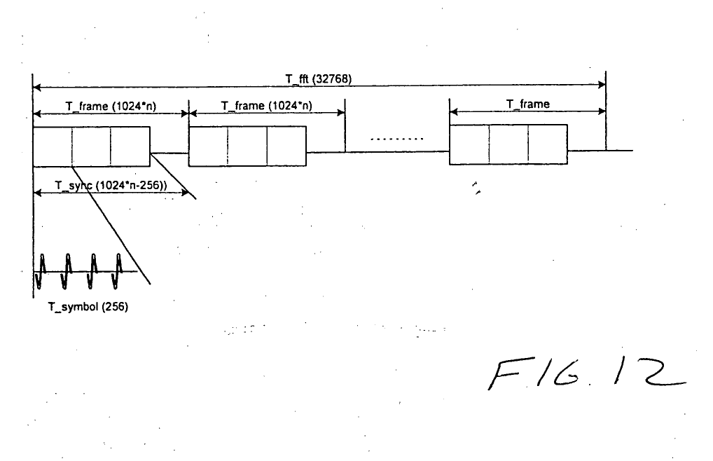

FIGS. 13A-13C are results obtained using scheme proposed in the previously described exemplary embodiment, FIGS. 13D-13F are results obtained using the scheme proposed in this alternative exemplary embodiment, and FIGS. 13G-13I are the results of randomly and independently generated pulses. The results showed that:

The PSD of randomly and independently generated pulses can be considered as the statistic low bound of the PSD. It is used in the simulation as a reference to evaluate the performance of the proposed scheme.

The PSD of this proposed scheme shown in FIG. 13F is very close to that of the reference shown in FIG. 13I. The peak value of the PSD of the former is almost the same as that of the reference.

For the configured simulation, this proposed scheme as shown in FIG. 13F has better performance in suppressing PSD by about 10 dB than the scheme proposed in the previously described exemplary embodiment shown in FIG. 13C.

Using the proposed scheme to generate a sync word, receivers need to calculate N*M symbol-based correlations for initial acquisition. Because the index to the scrambler array for the next frame can be calculated during the current frame, the sync word for the following frames can be predicted; therefore only an N symbol-based correlation is needed after initial acquisition. This results in a much simple implementation.

In order to effectively suppress line frequencies, the bi-orthogonal scheme is implemented on the basic element of pulses.

Unlike polynomial-based scramblers, the proposed scrambler is free of error propagation and the sync words for following frames are predictable.

A mechanism has been described above which suppresses ripples in and reduces the peak value of the PSD of ‘sync words’ for frame synchronization. The mechanism can also be extended to other constant data and to slowly changing non-payload data. It may be used in UWB multiple access communications and ad-hoc networks.

Although the components of the present invention have been described in terms of specific components, it is contemplated that one or more of the components may be implemented in software running on a general purpose computer. In this embodiment, one or more of the functions of the various components may be implemented in software that controls the general purpose computer. This software may be embodied in a computer readable carrier, for example, a magnetic or optical disk, a memory-card or an audio frequency, radio-frequency or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

The invention claimed is:

1. A signal processing method for reducing discrete components of an Ultra Wideband signal that includes source data having a repetitive component, the method comprising the steps of:
scrambling at least a portion of the repetitive component of the source data;
inverting portions of the source data including at least portions of the repetitive component according to a predetermined inverting function; and
preparing the scrambled and inverted source data for transmission.

2. The method of claim 1, wherein the source data includes symbols made up of pulses and the repetitive data includes sync words and wherein the inverting step comprises the step of:
selectively inverting symbols of the sync words according to the predetermined inverting function.

3. The method of claim 1, wherein the source data includes symbols made up of pulses and the repetitive data includes sync words and wherein the inverting step comprises the step of:
selectively inverting pulses of the sync words according to the predetermined inverting function.

4. The method of claim 1, wherein the source data includes frames and the inverting step comprises the step of:
selectively inverting the frames according to the predetermined inverting function.

5. The method of claim 1, wherein the inverting step comprises the step of:
selectively inverting the source data using a set of evenly distributed binary numbers.

6. The method of claim 1, wherein the source data includes words and wherein the scrambling step comprises the step of:
scrambling words of the repetitive data with a set of scramble words according to a predetermined scrambling function.

7. A signal processing system for reducing discrete components of an Ultra Wideband signal that includes source data having a repetitive component, the system comprising:
means for scrambling at least a portion of the repetitive component of the source data;
means for inverting portions of the source data including at least portions of the repetitive component according to a predetermined inverting function; and
means for preparing the scrambled and inverted source data for transmission.

8. The system of claim 7, wherein the source data includes symbols made up of pulses and the repetitive data includes sync words and wherein the inverting means comprises:
means for selectively inverting symbols of the sync words according to the predetermined inverting function.

9. The system of claim 7, wherein the source data includes symbols made up of pulses and the repetitive data includes sync words and wherein the inverting means comprises:
means for selectively inverting pulses of the sync words according to the predetermined inverting function.

10. The system of claim 7, wherein the source data includes frames and the inverting means comprises:
means for selectively inverting the frames according to the predetermined inverting function.

11. The system of claim 7, wherein the inverting means comprises:
means for selectively inverting the source data using a set of evenly distributed binary numbers.

12. The system of claim 7, wherein the source data includes words and wherein the scrambling means comprises:
means for scrambling words of the repetitive data with a set of scramble words according to a predetermined scrambling function.

13. A signal processing apparatus for reducing discrete components of an Ultra Wideband (UWB) signal that includes UWB source data having a repetitive component, the apparatus comprising:
a scrambler configured to receive the UWB source data and scramble at least a portion of the repetitive component;
an inverter coupled to the scrambler, the inverter configured to invert portions of the scrambled UWB source data according to a predetermined inverting function; and
a transmitter coupled to the inverter, the transmitter configured to transmit the scrambled and inverted UWB source data.

14. The apparatus of claim 13, wherein the UWB source data includes symbols made up of pulses and the repetitive data includes sync words and wherein the inverter selectively inverts symbols of the sync words according to the predetermined inverting function.

15. The apparatus of claim 13, wherein the UWB source data includes symbols made up of pulses and the repetitive data includes sync words and wherein the inverter selectively inverts pulses of the sync words according to the predetermined inverting function.

16. The apparatus of claim 13, wherein the UWB source data includes frames and the inverter selectively inverts the frames according to the predetermined inverting function.

17. The apparatus of claim 13, wherein the inverter selectively inverts the source data using a set of evenly distributed binary numbers.

18. The apparatus of claim 13, wherein the source data includes words and wherein the scrambler scrambles words of the repetitive data with a set of scramble words according to a predetermined scrambling function.

19. A computer readable medium including software that is configured to control a general purpose computer to implement an Ultra Wideband signal processing method embodied in a computer readable medium for reducing discrete components of an Ultra Wideband signal that includes source data having a repetitive component, the processing method including the steps of:
scrambling at least a portion of the repetitive component of the source data;
inverting portions of the source data including at least portions of the repetitive component according to a predetermined inverting function; and
preparing the scrambled and inverted source data for transmission.

20. The computer implemented method of claim 19, wherein the source data includes symbols made up of pulses and the repetitive data includes sync words and wherein the inverting step for implementation by the general purpose computer comprises the step of:
selectively inverting symbols of the sync words according to the predetermined inverting function.

21. The computer implemented method of claim 19, wherein the source data includes symbols made up of pulses and the repetitive data includes sync words and wherein the inverting step for implementation by the general purpose computer comprises the step of:
selectively inverting pulses of the sync words according to the predetermined inverting function.

22. The computer implemented method of claim 19, wherein the source data includes frames and the inverting step for implementation by the general purpose computer comprises the step of:
selectively inverting the frames according to the predetermined inverting function.

23. The computer implemented method of claim 19, wherein the inverting step for implementation by the general purpose computer comprises the step of:
selectively inverting the source data using a set of evenly distributed binary numbers.

24. The computer implemented method of claim 19, wherein the source data includes words and wherein the scrambling step for implementation by the general purpose computer comprises the step of:
scrambling words of the repetitive data with a set of scramble words according to a predetermined scrambling function.

25. A signal processing method for reducing discrete components of a transmitted Ultra Wideband signal that includes source data having a repetitive component, the method comprising the steps of:
defining a set of scramble words to scramble the repetitive data within the source data;
scrambling at least a portion of the repetitive component of the source data with the set of scramble words according to a predetermined scrambling function;
inverting portions of the scrambled source data according to a predetermined inverting function; and
transmitting the scrambled and inverted source data.

26. The method of claim 25, further comprising the steps of:
receiving the scrambled and inverted source data;
reinverting the inverted portions of the scrambled and inverted source data according to the predetermined inverting function; and
descrambling the scrambled source data according to a predetermined descrambling function based on the predetermined scrambling function to obtain the source data.

27. The method of claim 26, further comprising the steps of:
synchronizing the received scrambled and inverted source data for reinversion and descrambling using the predetermined inverting and descrambling functions.
